(19) United States
(12) Patent Application Publication
(10) Pub. No.: US 2007/0249232 A1
(43) Pub. Date: Oct. 25, 2007

(54) ELECTRICAL CONNECTOR

(75) Inventor: Takahito Haneishi, Tokyo (JP)

Correspondence Address: ABELMAN, FRAYNE & SCHWAB, 666 THIRD AVENUE, 10TH FLOOR, NEW YORK, NY, 10017, US

(73) Assignee: DDK LTD., Tokyo (JP)

(21) Appl. No.: 11/737,263

(22) Filed: Apr. 19, 2007

(30) Foreign Application Priority Data
Apr. 20, 2006 (JP) JP2006116243

(51) Int. Cl. H01R 24/00

(52) U.S. Cl. 439/630

(57) ABSTRACT

An electrical connector includes a plurality of contacts having a contact portion adapted to contact the memory card and arranged above and below, and a housing for arranging and holding the contacts and having a fitting opening into which a memory card is inserted. The housing is on the side of the contacts arranged below with at least two projections located on the side of insertion of the memory card and projecting into the fitting opening, and the projections having an inducing portion at their innermost end in the inserting direction of the memory card. With the electrical connector thus constructed, a memory card can be inserted into the connector without deforming the contacts, and memory card can be prevented from swiftly dashing out of the connector by the action of contact forces of the contacts when removing the memory card from the electrical connector.

### BACKGROUND OF THE INVENTION

This invention relates to an electrical connector for use in electric and electronic appliances such as printers, computers and the like, and more particularly to an electrical connector for a memory card, having a structure for preventing the memory card from dashing out from the connector when removing the memory card by utilizing a guiding mechanism for a memory card and parts of the guiding mechanism.

For the exchange of signals (information) between a mother board and a daughter board, a plurality of electrical connectors are fixed to the mother board by soldering or the like, and the daughter board is inserted into one of the electrical connectors. More specifically, the electrical connectors each comprise at least a housing having a fitting opening into which the daughter board is inserted, and contacts arranged in and held by the housing to extend into the fitting opening.

An electrical connector having a structure for inserting a substrate into the connector with ease has been disclosed in Japanese Patent Application Opened No. H8-250,238 (1996) (Patent Literature 1). Moreover, the applicant of the present application has already proposed an electrical connector as described above in Japanese Patent Application Opened No. 2002-94,266 (Patent Literature 2).

Patent Literature 1

According to the abstract of the Japanese Patent Application Opened No. H8-250,238 (1996), this invention has an object to provide an edge connector into which a substrate can be smoothly inserted without being erroneously angled. This connector includes a housing 2 formed with a guide member 7 having one end integrally formed with the housing 2, the guide member 7 being constructed to be rockable between a guide position where the upper end 73 of the other end 72 extends from a substrate loading surface 22e and a storage position where the upper end 73 is flush with the substrate loading surface 22e. When the upper end 73 of the guide member 7 in the guide position abuts against the lower surface of a substrate, the substrate is raised at a predetermined angle, under which condition the substrate is caused to be inserted with its lower surface abutting against and sliding on the upper end 73 so that the substrate can be inserted into a receiving space 21a under a raised condition that the rear portion of the substrate is raised at the predetermined angle relative to arm portions.

Incidentally, claim 1 recites an edge connector including a housing formed from a plastic material having a body section formed with a receiving space for receiving the front end of a substrate and arm portions extending rearward from both the right and left ends of the body section, a plurality of contacts arranged in alignment with one another in said receiving space and adapted to abut against conductive pads formed on the front end of said substrate when the front end of said substrate is received in the receiving space, and locking means provided on said arm portions for holding and fixing said substrate extending along said arm portions and with said front end received in said receiving space, and said conductive pads and said contacts being pushed and contacted each other by pushing down said substrate from a raised position where the front end of said substrate is inserted in said receiving space and the rear end of said substrate is raised relative to said arm portions at a predetermined angle to a mounting position where the lower surface of said substrate abuts against a substrate loading surface formed in said arm portions, characterized in comprising a guide member having one end integrally formed with said housing, and said guide member being rockable between a guide position where the upper end of the other end of said guide member extends upwardly from said substrate loading surface and abuts against the lower surface of said substrate when it is received in said receiving space so that said substrate is raised at said predetermined angle and is guided under the raised condition so as to be inserted into said raised position and a storage position where when said substrate is being pushed downwardly to said mounting position, said guide member is moved downwardly together with the substrate so that said upper end comes into flush with said substrate loading surface.

Patent Literature 2

According to the abstract of the Japanese Patent Application Opened No. 2002-94,266, this invention has an object to provide an electrical connector achieving a stable electrical connection irrespective of the weight of a substrate without disconnection of ejector locks upon vibration or impact. Disclosed is an electrical connector including a required number of contacts, a housing holding and fixing the contacts and having guide portions on both longitudinal ends and a fitting opening into which a substrate is inserted, and ejector locks pivotally mounted on the guide portions, respectively, wherein lock protection members are provided on the guide portions, respectively, to prevent engaging portions of the ejector locks from disengaging from anchoring portions of the substrate when the substrate is inserted into the fitting opening. Further, an electrical connector is disclosed, whose guide protrusions can guide lock protection members which are slidably moving.

Incidentally, claim 1 recites an electrical connector including a required number of contacts, a housing holding and fixing the contacts and having guide portions on both longitudinal ends and a fitting opening into which a substrate is inserted, and ejector locks pivotally mounted on said guide portions, respectively, wherein lock protection members are provided on said guide portions, respectively, to prevent engaging portions of the ejector locks from disengaging from anchoring portions of the substrate when the substrate is inserted into the fitting opening. Claim 2 recites the electrical connector as claimed in claim 1, in which said lock protection members are slidably mounted on the electrical connector in the direction of its thickness. Claim 3 recites the electrical connector as claimed in claim 1, in which said ejector locks are each provided on both sides in its width direction with anchoring grooves, and said lock protection members are each provided on the insides in its width direction with engaging protrusions so that the engaging protrusions of the lock protection members engage the anchoring grooves of the ejector locks when the substrate is inserted to be engaged in the ejector locks. Claim 4 recites the electrical connector as claimed in claim 2, in which said lock protection members are each provided on both the right and left sides with guide projections A and B, and when the lock protection members are slidably moved, they are guided by means of said guide projections. Claim 5 recites the electrical connector as claimed in claim 4, in which said lock protection members are each provided with a protrusion on the side of the substrate inserting direction of the guide projection B, thereby enhancing the holding for the ejector locks against their pivotal movement by means of said protrusions.

Recently, with the even more miniaturization of connectors, amounts of information to be exchanged have been increased. In order to increase memoried information, therefore, an electrical connector connected to a mother board is sometimes provided with a memory card for increasing capacity.

With the connectors disclosed in the Patent Literatures 1 and 2, as said contacts extend into the fitting opening into which a memory card is inserted, said contacts are often deformed by the front end of the memory card being inserted so that the deformed contacts tend to cause a problem of defective or failed connection.

With the electrical connectors of the prior art inventions, moreover, when a memory card is removed from the electrical connector, the memory card would be swiftly dashed out of the connector by the action of contact forces of the contacts arranged above and below, resulting in sometimes a breakage of the memory card which is one problem to be solved.

In the prior art inventions, furthermore, the locking means for locking a memory card is made of an insulating material integrally formed with said housing so that the locking means would be often damaged upon being displaced or deformed.

### SUMMARY OF THE INVENTION

In view of the problems of the prior art, the invention has an object to provide an electrical connector having a construction permitting a memory card to be inserted without causing contacts to be deformed and preventing the memory card from swiftly dashing out of the electrical connector when the memory card is being removed.

The object described above can be achieved by the electrical connector 10 into and from which a memory card 70 is inserted and removed, including a plurality of contacts 14 and 16 having a contact portion 141, 161 adapted to contact said memory card 70 and arranged above and below, and a housing 12 for arranging and holding said contacts 14 and 16 and having a fitting opening 20 into which said memory card 70 is inserted, according to the invention said housing 12 is provided on the side of said contacts 16 arranged below with at least two projections 30 located on the side of insertion of said memory card and projecting into said fitting opening 20, and said projections 30 having an inducing portion 28 at their innermost end in the inserting direction of said memory card.

The height of said projections 30 is lower than that of the contact portions 161 of said contacts 16, while enabling contact forces of said contacts 16 to be maintained.

Moreover, forward ends of said projections 30 extend into the forward direction of the insertion of said memory card so that when said memory card 70 is being removed, said memory card 70 is embraced between the contact portions 141 of said contacts 14 arranged above and the extended inducing portions 28 of said projections 30.

Forward ends of said projections 30 extend into the forward direction of the insertion of said memory card so that when said memory card 70 is being removed, said memory card 70 is pushed toward said projections 30 by the contact forces of said contacts 14 arranged above, whereby the front end of said memory card is held at the forward ends of the inducing portions of said projections.

Further, said housing 12 is provided at each of both ends with an extension portion 24 extending onto the side of insertion of said memory card, and said extension portion 24 is provided at its tip with a locking portion 32 for locking said memory card 70 and further provided at the tip with a fixture 18 to be fixed to a substrate 60 (not shown), said fixture 18 integrally comprising a reinforcing portion 36 for reinforcing said locking portion 32 and a plate-shaped piece 40 for limiting the movement of said locking portion 32.

The electrical connector according to the invention is capable of receiving a memory card so as to avoid any deformation of said contacts and capable of preventing the memory card from swiftly dashing out of the electrical connector by contacting forces of the contacts when the memory card is being removed, thereby eliminating the problems of the prior art inventions.

As can be seen from the above descriptions the electrical connector 10 according to the invention has the following significant functions and effects.

(1) In the electrical connector 10 into and from which a memory card 70 is inserted and removed, including a plurality of contacts 14 and 16 having a contact portion 141, 161 adapted to contact said memory card 70 and arranged above and below, and a housing 12 for arranging and holding said contacts 14 and 16 and having a fitting opening 20 into which said memory card 70 is inserted, according to the invention said housing 12 is provided on the side of said contacts 16 arranged below with at least two projections 30 located on the side of insertion of said memory card and projecting into said fitting opening 20, and said projections 30 having an inducing portion 28 at their innermost end in the inserting direction of said memory card. Therefore, upon insertion of the memory card 70, said contacts 16 are not deformed at all.

(2) According to the invention, the height of said projections 30 is lower than that of the contact portions 161 of said contacts 16, while enabling contact forces of said contacts 16 to be maintained. Consequently, upon insertion of the memory card 70, said contacts 16 are not deformed at all so that stable electrical connection can be securely accomplished.

(3) According to the invention, forward ends of said projections 30 extend into the forward direction of the insertion of said memory card so that when said memory card 70 is being removed, said memory card 70 is embraced between the contact portions 141 of said contacts 14 arranged above and the extended inducing portions 28 of said projections 30. Accordingly, when the memory card 70 is removed from the electrical connector, the memory card 70 can be prevented from swiftly dashing out of the electrical connector by the action of the contact forces of said contacts 14 and 16 so that damage of said memory card 70 can be avoided.

(4) According to the invention, forward ends of said projections 30 extend into the forward direction of the insertion of said memory card so that when said memory card 70 is being removed, said memory card 70 is pushed toward said projections 30 by the contact forces of said contacts 14 arranged above, whereby the front end of said memory card is held at the forward ends of the inducing portions of said projections. Consequently, when the memory card 70 is removed from the electrical connector, the memory card 70 can be prevented from swiftly dashing out of the electrical connector by the action of the contact forces of said contacts 14 and 16 so that damage of said memory card 70 can be avoided.

(5) According to the invention, said housing 12 is provided at each of both ends with an extension portion 24 extending onto the side of insertion of said memory card, and said extension portion 24 is provided at its tip with a locking portion 32 for locking said memory card 70 and further provided at the tip with a fixture 18 to be fixed to a substrate 60, said fixture 18 integrally comprising a reinforcing portion 36 for reinforcing said locking portion 32 and a plate-shaped piece 40 for limiting the movement of said locking portion 32. Therefore, as amount of displacement (movement) of the locking portions 32 can be limited, there is no risk of damage of the locking portions 32. Further, as the fixtures 18 are integrally provided, stable connection of the electrical connector to the substrate 60 can be achieved.

The invention will be more fully understood by referring to the following detailed specification and claims taken in connection with the appended drawings.

### BRIEF DESCRIPTION OF THE DRAWINGS

FIG. 1A is a perspective view of the electrical connector according to the invention viewed from the fitting side;

FIG. 1B is a perspective view of the electrical connector according to the invention viewed from the connection side;

FIG. 1C is a partly enlarged perspective view of the electrical connector according to the invention viewed from the fitting side;

FIG. 2A is a perspective view of the electrical connector according to the invention with a memory card inserted;

FIG. 2B is a perspective view of the electrical connector according to the invention and the memory card before being inserted;

FIG. 3A is a sectional view of the electrical connector according to the invention with the memory card inserted;

FIG. 3B is a sectional view of the electrical connector with the memory card whose forward end is caught in the housing when the memory card is being removed;

FIG. 4A is a partly enlarged sectional view of part of FIG. 3A;

FIG. 4B is a partly enlarged sectional view of part of FIG. 3B;

FIG. 5A is a perspective view of an upper contact;

FIG. 5B is a perspective view of a lower contact;

FIG. 6 is a perspective view of the housing; and

FIG. 7 is a perspective view of the fixture.

### DESCRIPTION OF THE PREFERRED EMBODIMENTS

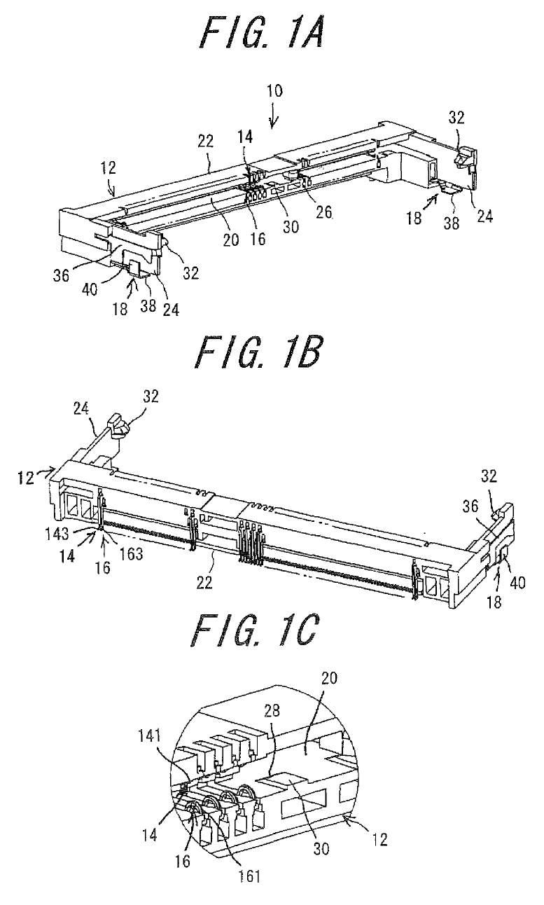

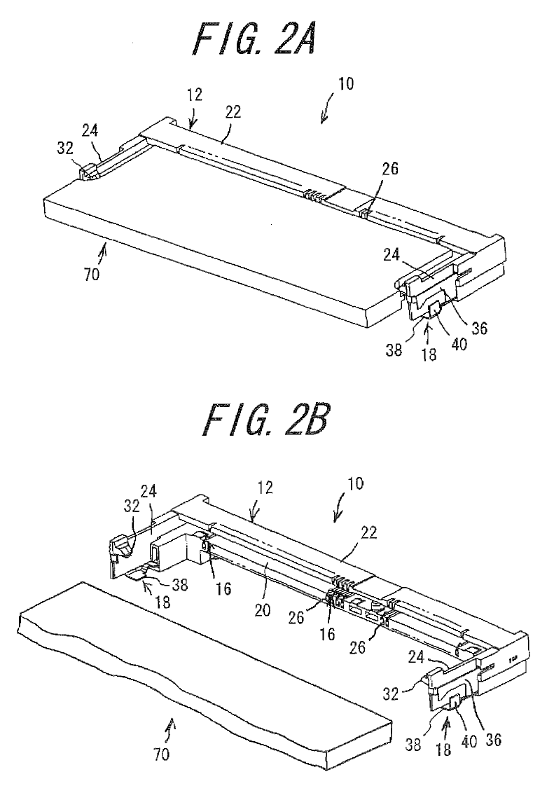

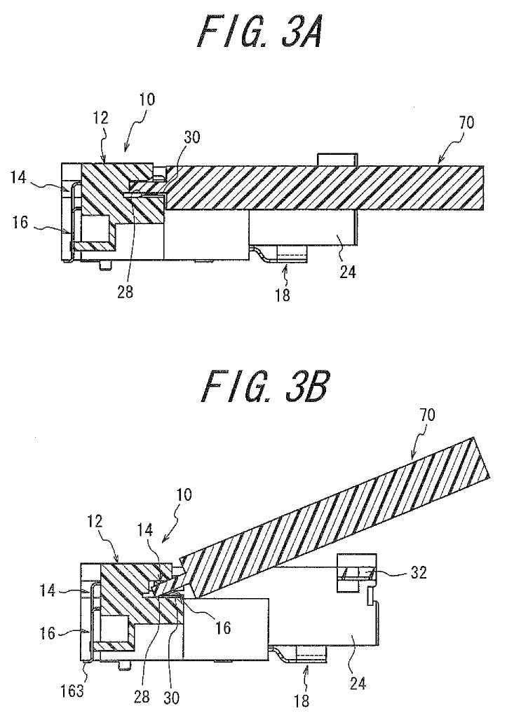

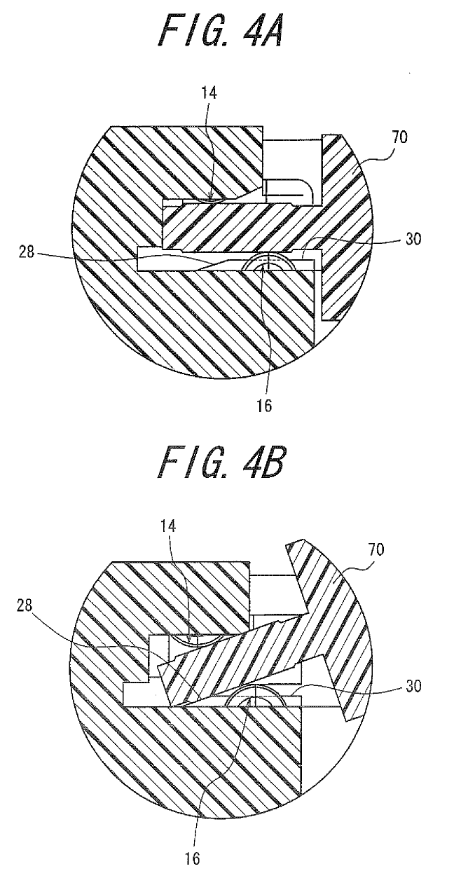

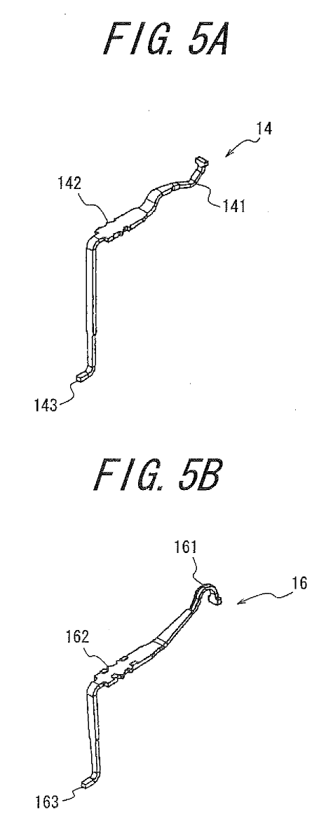

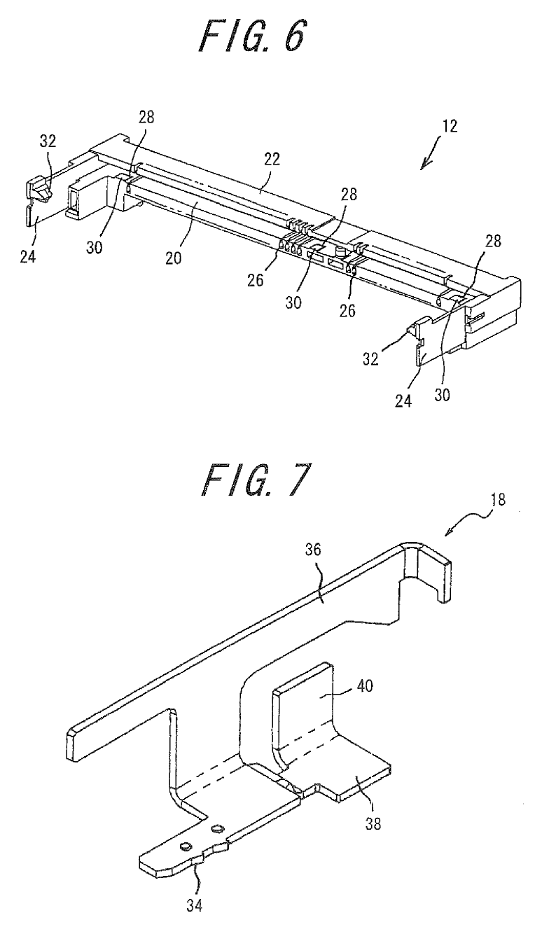

One embodiment of the invention will be explained with reference to FIG. 1A to FIG. 7. FIG. 1A is a perspective view of the electrical connector according to the invention viewed from its fitting side, and FIG. 1B is a perspective view of the electrical connector according to the invention viewed from its connection side. FIG. 1C is a partly enlarged perspective view of the electrical connector according to the invention viewed from its fitting side. FIG. 2A is a perspective view of the electrical connector according to the invention with a memory card inserted, while FIG. 2B is a perspective view of the electrical connector according to the invention and the memory card not inserted. FIG. 3A is a cross-sectional view of the electrical connector according to the invention with the memory card inserted, and FIG. 3B is a cross-sectional view of the state that the tip of a memory card is caught in the housing when the memory card is being removed from the housing. FIG. 4A is a partly enlarged sectional view of FIG. 3A, while FIG. 4B is a partly enlarged sectional view of FIG. 3B. FIG. 5A is a perspective view of an upper contact, while FIG. 5B is a perspective view of a lower contact. FIG. 6 is a perspective view of a housing, and FIG. 7 is a perspective view of a fixture.

The electrical connector 10 according to the invention mainly comprises a plurality of contacts 14 and 16, a housing 12, and locking portions 32.

Before explaining the components of the electrical connector according to the invention, memory cards 70 (daughter boards) will be explained. Said memory cards 70 are used for personal computers, servers, printers, and the like. Said memory cards 70 each mainly comprise contact portions adapted to contact the contact portions 141 and 161 of the contacts 14 and 16, patterns connecting from the contact portions of the memory card to circuits, and connection portions adapted to be connected to integrated circuits and central processing units mounted on the patterns. The memory cards 70 for use in the electrical connector 10 according to the invention include DIMM memory card, SO-DIMM memory card, exclusive memory card and the like.

With the card connector 10 of the illustrated embodiment, the DIMM memory card is used.

First, the housing 12 will be explained which is one subject matter of the invention. The housing 12 is formed from an electrically insulating plastic material by means of the injection molding of the known technique. The materials for the housing 12 may be suitably selected in consideration of dimensional stability, workability, manufacturing cost and the like, and generally include polybutylene terephthalate (PBT), polyamide (66PA or 46PA), liquid crystal polymer (LCP), polycarbonate (PC) and the like and combination thereof.

Said housing 12 in the illustrated embodiment comprises a body section 22 and extension portions 24 integrally extending from the body section 22 on both sides. The body section 22 of said housing 12 is provided with a fitting opening 20 into which said memory card 70 is inserted. The size of said fitting opening 20 may be suitably designed so that a required number of said memory cards can be inserted into the fitting opening 20, and upon the memory card 70 being inserted, it is able to contact the contacts 14 and 16 oppositely arranged in upper and lower positions of the fitting opening.

The body section 22 is provided with a plurality of inserting holes 26 in an upper and a lower row for arranging and holding said contacts 14 and 16 above and below, respectively. The sizes of said inserting holes 26 may be suitably deigned so that said contacts 14 and 16 can be held, and the contact portions 141 and 161 of said contacts 14 and 16 can contact said memory card 70 at a constant contact pressure.

In the fitting opening 20 of said housing 12, there are provided at least two projections 30 projecting into said fitting opening on the side of said contacts 16 arranged below on the side of the insertion of the memory card and extending into the inserting direction of the memory card. It is desirable to provide an inducing portion 28 at the forward end (on the opposite side to the fitting opening 20) of each of said projections 30. Said projections 30 may be suitably designed so that their height is lower than that of the contact portions 161 of said contacts 16 and contact forces of said contacts 16 can be maintained. Said inducing portion 28 in the illustrated embodiment is an inclined face, and the angle of the inclined face may be suitably designed in consideration of angles of said memory card 70 when being inserted and removed, and embracing said memory card between the upper and lower contacts 14 and 16.

The projections 30 are preferably provided at least one on each end of the body section, i.e. a total of at least two projections in consideration of balancing when said memory card 70 is being inserted. If the balancing is more important, it is desirable to provide the projections 30 one at each of both the end and the center, i.e. a total of three projections.

Moreover, it is desirable to extend the forward ends of the projections 30 in the inserting direction of said memory card toward the rear end of the connector. With such extended forward ends of said projections 30, when said memory card 70 is being removed, said memory card 70 is desirably embraced between the contact portions 141 of said contacts 14 located in the upper positions and the inducing portions of said extended projections 30 so that said memory card 70 being removed is pressed toward said projections 30 by the contact forces of said contacts 14, with the result that the front end of said memory card is caught by the tips of the inducing portions 28 of said projections 30. In this way, said memory card 70 is prevented from swiftly dashing out of the housing 12 by the contact forces of said contacts 14 and 16 when said memory card 70 is being removed. The distance to which the forward ends of the projections extend forwardly may be suitably designed in consideration of such a function.

In the illustrated embodiment, the extension portions 24 of said housing 12 are each provided at the free end with a locking portion 32 adapted to lock said memory card 70. The locking portions 32 serve to hold said memory card 70, and when said memory card 70 is being removed, the locking portions 32 move away from each other to release said memory card 70 therefrom. The size and shape of said locking portions 32 may be suitably designed in consideration of such functions.

The fixtures 18 will then be explained. Said fixtures 18 are made of a metal and formed by means of the press-working of the known technique. Preferred metals from which to form said fixtures 18 include brass, beryllium copper, phosphor bronze and the like which comply with the requirements as to springiness, dimensional stability, workability, and the like.

The fixture 18 in the illustrated embodiment at least comprises a fixing portion 38 to be fixed to a substrate 60, a reinforcing portion 36 for reinforcing the extension portion 24 of said housing 12, a plate-shaped piece 40 for limiting the movement of said locking portion 32, and a holding portion 34 for holding the fixture 18 with respect to the housing 12.

Although said fixing portion 38 in the illustrated embodiment is of a surface mounting type (S MT) in view of the circuit design of the substrate 60, it may be of a dip type. As the holding portion 34 is fixed to the housing by press-fitting in the illustrated embodiment, the holding portion 34 is formed to have an interference for press fitting.

Said reinforcing portion 36 serves to reinforce said extension portion 24 and abuts against the extension portion 24 on the opposite side of said locking portion 32.

Said plate-shaped piece 40 serves to limit the moving distance of said extension portion 24 (locking portion 32). The space between said plate-shaped piece 40 and said extension portion 24 may be suitably designed in consideration of removal of said memory card 70, the strength of said extension portion 24, workability and the like of the fixture 18.

Finally, the contacts 14 and 16 of the two kinds arranged above and below will be explained. Said contacts 14 and 16 are made of a metal and formed by means of the press-working of the known technique. Preferred metals from which to form said contacts 14 and 16 include brass, beryllium copper, phosphor bronze and the like which comply with the requirements as to springiness, electric conductivity, dimensional stability, and the like.

Said contacts 14 and 16 each at least comprise a contact portion 141, 161 adapted to contact said memory card 70, a fixed portion 142, 162 to be fixed to said housing 12, and a connection portion 143, 163 to be connected to the substrate 60. The shapes of said contact portions 141 and 161 are curved to cause them to contact said memory card easily. Although said connection portions 143 and 163 of said contacts 14 and 16 are of a surface mounting type (SMT) in consideration of the circuit design of the substrate 70 in the illustrated embodiment, they may be of a dip type. Said contacts 14 and 16 are arranged in a manner that said contact portions 141 and 161 are facing to each other and staggered relative to each other in the directions of the rows.

When said memory card 70 is being removed, the memory card 70 is embraced between the contact portions 141 of said contacts 14 in the upper positions and the inducing portions 28 of said projections 30 so that said memory card 70 is pushed toward said projections 30 by the contact forces of said contacts 14 arranged in the upper positions upon movement of the memory card 70 to be removed, whereby the front end of the memory card 70 is caught by the forward ends of the inducing portions of said projections 30.

Said contacts 14 and 16 are fixed to said housing by means of press-fitting, hooking (lancing), welding or the like.

Examples of application of the present invention are electrical connectors for use in electric or electronic appliances such as printers, computers and the like, and more particularly electrical connectors having a structure for preventing the memory card from swiftly dashing out of the connector when removing the memory card by utilizing a guiding mechanism for a memory card and the parts of the guiding mechanism.

While the invention has been particularly shown and described with reference to the preferred embodiments thereof, it will be understood by those skilled in the art that the foregoing and other changes in form and details can be made therein without departing from the spirit and scope of the invention.

What is claimed is:

1. An electrical connector into and from which a memory card is inserted and removed, including a plurality of contacts having a contact portion adapted to contact said memory card and arranged above and below, and a housing for arranging and holding said contacts and having a fitting opening into which said memory card is inserted,
wherein said housing is provided on the side of said contacts arranged below with at least two projections located on the side of insertion of said memory card and projecting into said fitting opening, and said projections having an inducing portion at their innermost end in the inserting direction of said memory card.

2. The electrical connector as set forth in claim 1, wherein the height of said projections is lower than that of the contact portions of said contacts, while enabling contact forces of said contacts to be maintained.

3. The electrical connector as set forth in claim 1, wherein forward ends of said projections extend into the forward direction of the insertion of said memory card so that when said memory card is being removed, said memory card is embraced between the contact portions of said contacts arranged above and the extended inducing portions of said projections.

4. The electrical connector as set forth in claim 1, wherein forward ends of said projections extend into the forward direction of the insertion of said memory card so that when said memory card is being removed, said memory card is pushed toward said projections by the contact forces of said contacts arranged above, whereby the front end of said memory card is held at the forward ends of the inducing portions of said projections.

5. The electrical connector as set forth in claim 1, wherein said housing is provided at each of both ends with an extension portion extending onto the side of insertion of said memory card, and said extension portion is provided at its tip with a locking portion for locking said memory card and further provided at the tip with a fixture to be fixed to a substrate, said fixture integrally comprising a reinforcing portion for reinforcing said locking portion and a plate-shaped piece for limiting the movement of said locking portion.

6. The electrical connector as set forth in claim 2, wherein forward ends of said projections extend into the forward direction of the insertion of said memory card so that when said memory card is being removed, said memory card is embraced between the contact portions of said contacts arranged above and the extended inducing portions of said projections.

7. The electrical connector as set forth in claim 2, wherein forward ends of said projections extend into the forward direction of the insertion of said memory card so that when said memory card is being removed, said memory card is pushed toward said projections by the contact forces of said contacts arranged above, whereby the front end of said memory card is held at the forward ends of the inducing portions of said projections.

8. The electrical connector as set forth in claim 2, wherein said housing is provided at each of both ends with an extension portion extending onto the side of insertion of said memory card, and said extension portion is provided at its tip with a locking portion for locking said memory card and further provided at the tip with a fixture to be fixed to a substrate, said fixture integrally comprising a reinforcing portion for reinforcing said locking portion and a plate-shaped piece for limiting the movement of said locking portion.

9. The electrical connector as set forth in claim 3, wherein said housing is provided at each of both ends with an extension portion extending onto the side of insertion of said memory card, and said extension portion is provided at its tip with a locking portion for locking said memory card and further provided at the tip with a fixture to be fixed to a substrate, said fixture integrally comprising a reinforcing portion for reinforcing said locking portion and a plate-shaped piece for limiting the movement of said locking portion.

10. The electrical connector as set forth in claim 4, wherein said housing is provided at each of both ends with an extension portion extending onto the side of insertion of said memory card, and said extension portion is provided at its tip with a locking portion for locking said memory card and further provided at the tip with a fixture to be fixed to a substrate, said fixture integrally comprising a reinforcing portion for reinforcing said locking portion and a plate-shaped piece for limiting the movement of said locking portion.

11. The electrical connector as set forth in claim 6, wherein said housing is provided at each of both ends with an extension portion extending onto the side of insertion of said memory card, and said extension portion is provided at its tip with a locking portion for locking said memory card and further provided at the tip with a fixture to be fixed to a substrate, said fixture integrally comprising a reinforcing portion for reinforcing said locking portion and a plate-shaped piece for limiting the movement of said locking portion.

12. The electrical connector as set forth in claim 7, wherein said housing is provided at each of both ends with an extension portion extending onto the side of insertion of said memory card, and said extension portion is provided at its tip with a locking portion for locking said memory card and further provided at the tip with a fixture to be fixed to a substrate, said fixture integrally comprising a reinforcing portion for reinforcing said locking portion and a plate-shaped piece for limiting the movement of said locking portion.
